(19) United States
(12) Patent Application Publication
(10) Pub. No.: US 2026/0347592 A1
(43) Pub. Date: Nov. 5, 2026

(54) WATER-SOLUBLE FILM AND CHEMICAL AGENT PACKAGE

(71) Applicant: MITSUBISHI CHEMICAL CORPORATION, Tokyo (JP)

(72) Inventors: Kenji KANETA, Tokyo (JP); Madoka TERAZAWA, Tokyo (JP); Nobuyoshi YOSHIMURA, Tokyo (JP)

(73) Assignee: MITSUBISHI CHEMICAL CORPORATION, Tokyo (JP)

(21) Appl. No.: 19/709,591

(22) Filed: Jun. 16, 2026

Related U.S. Application Data
(63) Continuation of application No. PCT/JP2025/011957, filed on Mar. 26, 2025.

(30) Foreign Application Priority Data
Mar. 27, 2024 (JP) 2024-051594

(51) Int. Cl. C08L 29/04; C08J 5/18; C08K 5/053; C08L 3/02; C11D 17/04

(52) U.S. Cl. CPC C08L 29/04; C08J 5/18; C08K 5/053; C08L 3/02; C11D 17/043; C08J 2303/02; C08J 2329/04; C08J 2403/02; C08J 2429/04; C08L 2203/162; C08L 2205/025; C08L 2205/03; C08L 2205/06

(57) ABSTRACT

Provided is a water-soluble film containing a polyvinyl alcohol-based resin, an unmodified starch, and a plasticizer, wherein

the polyvinyl alcohol-based resin contains a modified polyvinyl alcohol-based resin,
the unmodified starch has an amylopectin content of 85% or greater, and
a proportion of the unmodified starch is from 20 to 78 mass % with respect to a total mass of the unmodified starch and the plasticizer,
which has excellent mechanical properties such as film strength and degree of elongation, and moldability as well as excellent sealability.

### RELATED APPLICATIONS

This application is a continuation of International Application No. PCT/JP2025/011957, filed on Mar. 26, 2025, which claims priority to Japanese Patent Application No. 2024-051594, filed on Mar. 27, 2024, the entire contents of each of which are herein incorporated by reference.

### TECHNICAL FIELD

The present disclosure relates to a water-soluble film containing an unmodified starch. More specifically, the present disclosure relates to a water-soluble film containing a polyvinyl alcohol-based resin and an unmodified starch, and a chemical agent package using the same.

In recent years, from the viewpoint of protection of the global environment, to replace known plastic films made of petroleum-based raw materials, development of a film having higher biodegradability using natural raw materials has been expected.

For example, Patent Literature 1 describes a starch composition containing a starch having an amylopectin content of 70% or greater as a natural raw material and a polyvinyl alcohol-based resin having a degree of saponification of 96 mol % or less, a proportion of the starch being from 40 to 90 mass % and a proportion of the polyvinyl alcohol-based resin being from 10 to 60 mass % with respect to a total mass of the starch and the polyvinyl alcohol-based resin. Also, Patent Literature 1 describes that a film, a fiber, and the like using the starch composition have high water solubility and biodegradability.

### CITATION LIST

### Patent Literature

Patent Literature 1: WO 2023/276402

### SUMMARY

### Technical Problem

When a film is produced by using the starch composition of Patent Literature 1, the resulting film has poor mechanical properties such as strength and stretchability, and poor moldability. Thus, further improvement is desired, particularly for use in individual package applications for a food product, a chemical agent, or the like. For individual package applications, particularly for liquid packaging, there is a concern that poor strength in a sealing part may cause liquid leakage. Thus, further improvement is desired.

Accordingly, under the above circumstances, an object of the present disclosure is to provide a water-soluble film having excellent mechanical properties such as film strength and degree of elongation, and moldability as well as excellent sealability.

### Solution to Problem

As a result of diligent research in light of such circumstances, the inventors of the present disclosure found that a water-soluble film having excellent mechanical properties, moldability, and sealability can be obtained by, in a water-soluble film containing a polyvinyl alcohol-based resin, an unmodified starch, and a plasticizer, using a modified polyvinyl alcohol-based resin as the polyvinyl alcohol-based resin, using an unmodified starch having an amylopectin content of 85% or greater as the unmodified starch, and setting a content of the unmodified starch to be in a specific range with respect to a total mass of the unmodified starch and the plasticizer.

In addition, because the polyvinyl alcohol-based resin is a biodegradability resin, the problems described above can be solved without significantly reducing the biodegradability of the whole water-soluble film, and a proportion of petroleum-based raw materials can be reduced compared to that of a water-soluble film made of a known polyvinyl alcohol-based resin.

That is, the present disclosure provides the following aspects.
[1] A water-soluble film containing a polyvinyl alcohol-based resin, an unmodified starch, and a plasticizer,
the polyvinyl alcohol-based resin containing a modified polyvinyl alcohol-based resin,
the unmodified starch having an amylopectin content of 85% or greater, and
a content of the unmodified starch being from 20 to 78 mass % with respect to a total mass of the unmodified starch and the plasticizer.
[2] The water-soluble film according to [1], wherein the content of the unmodified starch is from 20 to 60 mass % with respect to the total mass of the unmodified starch and the plasticizer.
[3] The water-soluble film according to [1] or [2], wherein the content of the unmodified starch is from 65 to 75 mass % with respect to the total mass of the unmodified starch and the plasticizer.
[4] The water-soluble film according to any one of [1] to [3], wherein the content of the unmodified starch is from 20 to 80 mass % with respect to a total mass of the polyvinyl alcohol-based resin and the unmodified starch.
[5] The water-soluble film according to any one of [1] to [4], wherein glycerin is contained as the plasticizer.
[6] The water-soluble film according to any one of [1] to [4], wherein glycerin and at least one additional plasticizer are contained as the plasticizer, and a mass ratio of glycerin to the at least one additional plasticizer [(glycerin)/(at least one additional plasticizer)] is from 95/5 to 10/90.
[7] The water-soluble film according to any one of [1] to [6], wherein an average degree of saponification of the polyvinyl alcohol-based resin is from 80 to 96 mol %.
[8] The water-soluble film according to any one of [1] to [7], wherein the water-soluble film is used for chemical agent packaging.
[9] A chemical agent package including a package formed of the water-soluble film described in any one of [1] to [8], and a chemical agent contained in the package.

### Advantageous Effects of Disclosure

The water-soluble film of the present disclosure has not only excellent mechanical properties and moldability, especially moldability into a complex shape, but also excellent sealability. Thus, the water-soluble film is suitable for individual package applications and is especially excellent as an individual package for a chemical agent and a food product.

### DESCRIPTION OF EMBODIMENTS

The present disclosure is described below with reference to embodiments for carrying out the present disclosure. However, the present disclosure is not limited to the embodiments described below.

In addition, in the present specification, an expression of “from X to Y” (where X and Y are any numbers) includes not only the meaning of “X or greater and Y or less” but also the meaning of “preferably greater than X” or “preferably less than Y”, unless otherwise specified.

Furthermore, the expression “X or greater” (X is any number) or “Y or less” (Y is any number) encompasses the meaning of “preferably greater than X” or “preferably less than Y”.

In the present specification, the wording “x and/or y (with x and y being any configurations)” means at least one selected from x and y, and includes the three meanings of only x, only y, and both x and y.

In the present specification, with respect to a numerical range described stepwise, the upper limit value or the lower limit value of the numerical range at one step can be optionally combined with the upper limit value or the lower limit value of the numerical range at another step. In addition, in a numerical range described in the present specification, the upper limit value or the lower limit value of the numerical range can be replaced with a value presented in Examples.

Hereinafter, the present disclosure will be described in detail.

### Water-Soluble Film

A “water-soluble film” in the present disclosure means a film that dissolves in water at about normal temperature (20 °C).

In the present disclosure, the solubility of the film is determined as described below.

Specifically, the film is cut into a size of 3 cm×5 cm, placed in a 1-liter beaker containing water (1 liter), and fixed with a jig, and the mixture is stirred with a stirrer (a rotator length of 3 cm, a rotation speed of 750 rpm) while the water temperature is kept at 20 °C. When insoluble fine particles of the film having a diameter of 1 mm or greater are not visually observed, such a case is regarded as dissolution.

The water-soluble film according to an embodiment of the present disclosure (hereinafter, may be referred to as “the present water-soluble film”) contains a polyvinyl alcohol-based resin, an unmodified starch, and a plasticizer. These will be described below.

Note that, in the present disclosure, the polyvinyl alcohol may be abbreviated as “PVA”.

In the present disclosure, the term “film” includes “tape” and “sheet”.

### PVA-Based Resin

The PVA-based resin is a resin mainly composed of vinyl alcohol structural units and is obtained by saponifying a vinyl ester-based resin obtained by polymerizing a vinyl ester-based monomer. The PVA-based resin is composed of a vinyl alcohol structural unit corresponding to the degree of saponification and a vinyl ester structural unit remained without being saponified.

Examples of the PVA-based resin include an unmodified PVA and a modified PVA-based resin. In the present disclosure, the PVA-based resin includes a modified PVA-based resin. One type of PVA-based resin may be used alone, or two or more types of PVA-based resins that differ in at least one of degree of saponification, viscosity, modification species, and degree of modification, may be contained.

As the modified PVA-based resin, from the viewpoints of miscibility with the unmodified starch and solubility of the film, an anion-modified PVA-based resin having an anionic group, examples of the anionic group including a carboxy group, a sulfonic acid group, and a phosphoric acid group, is preferred.

Examples of the type of the anionic group include a carboxy group, a sulfonic acid group, and a phosphoric acid group. From the viewpoint of temporal stability of solubility, a carboxy group and a sulfonic acid group are preferred, and a carboxy group is particularly preferred.

For example, the modified PVA-based resin can be produced by saponifying a copolymer of a vinyl ester-based compound and an unsaturated monomer and/or post-modifying an unmodified PVA.

The unmodified PVA can be produced by, for example, saponifying a polyvinyl ester-based resin obtained by polymerizing a vinyl ester-based compound.

Examples of the vinyl ester-based compound include vinyl formate, vinyl acetate, vinyl trifluoroacetate, vinyl propionate, vinyl butyrate, vinyl caprate, vinyl laurate, vinyl versatate, vinyl palmitate, and vinyl stearate. Vinyl acetate is preferably used. One type alone or a combination of two or more types thereof may be used as the vinyl ester-based compound.

When the modified PVA-based resin is the anion-modified PVA-based resin, an unsaturated monomer having an anionic group, such as a carboxy group-containing unsaturated monomer, a sulfonic acid group- or sulfonate group-containing unsaturated monomer, or a phosphoric acid group-containing unsaturated monomer may be used as the unsaturated monomer. One type of these can be used, or two or more types thereof may be used in combination.

Examples of the carboxy group-containing unsaturated monomer include carboxy group-containing unsaturated compounds, such as acrylic acid, methacrylic acid, crotonic acid, maleic acid, maleic anhydride, fumaric acid, and itaconic acid and compounds having these carboxy groups neutralized entirely or partially by a base such as an alkali compound (e.g., sodium hydroxide or potassium hydroxide), monoalkyl esters of the carboxy group-containing unsaturated compounds, such as methyl acrylate, ethyl acrylate, methyl methacrylate, monomethyl fumarate and monomethyl maleate, and dialkyl esters of the carboxy group-containing unsaturated compounds, such as diethyl fumarate and diethyl maleate. These esters each have usually from 1 to 20 carbons, preferably from 1 to 10 carbons, and particularly preferably from 1 to 4 carbons, from the viewpoints of economic efficiency and practicality.

In particular, a maleic acid-based compound is preferred. Further, monomethyl maleate is more preferred.

Examples of the sulfonic acid group- or sulfonate group-containing unsaturated monomer include olefin sulfonic acids, such as vinylsulfonic acid, allylsulfonic acid, and methallylsulfonic acid, and salts thereof; sulfoalkylmalates, such as sodium sulfopropyl-2-ethylhexylmalate, sodium sulfopropyl-2-ethylhexylmalate, sodium sulfopropyltridecylmalate, and sodium sulfopropyleicosylmalate; sulfoalkyl (meth)acrylamides, such as sodium sulfomethyl acrylamide, sodium sulfo-t-butylacrylamide, sodium sulfo-s-butylacrylamide, and sodium sulfo-t-butylmethacrylamide; and sulfoalkyl (meth)acrylates, such as sodium sulfomethyl acrylamide, sodium sulfo-t-butylacrylamide, sodium sulfo-s-butylacrylamide, and sodium sulfo-t-butylmethacrylamide.

Examples of the phosphoric acid group-containing unsaturated monomer include phosphonocarboxylic acid compounds or alkali metal salts thereof.

As the polymerization method of the vinyl ester-based compound and the unsaturated monomer or the polymerization method of the vinyl ester-based compound, a known polymerization method can be optionally used, such as a solution polymerization method, an emulsion polymerization method, or a suspension polymerization method, but a solution polymerization method using an alcohol such as methanol, ethanol, or isopropyl alcohol as a solvent is usually performed.

As a polymerization catalyst used in the polymerization method, a known polymerization catalyst can be appropriately selected depending on the polymerization method, example of the polymerization catalyst including an azo-based catalyst such as azobisisobutyronitrile and peroxide catalysts such as acetyl peroxide, benzoyl peroxide, and lauroyl peroxide. One type of these can be used, or two or more types thereof may be used in combination. The reaction temperature is selected from a range of approximately 35 °C to a solvent boiling point.

Saponification of the obtained copolymer of the vinyl ester-based compound and the unsaturated monomer or the polyvinyl ester-based resin can be performed by a known method. The saponification is usually performed by dissolving the obtained polymer in an alcohol and in the presence of a saponification catalyst. Examples of the alcohol include methanol, ethanol, and butanol. These can be used alone or in combination of two or more types thereof. The concentration of the copolymer in the alcohol is selected from a range of 20 to 50 mass % from the viewpoint of dissolution rate.

As the saponification catalyst, an alkali catalyst can be used, example of which including a hydroxide or alcoholate of an alkali metal, for example, sodium hydroxide, potassium hydroxide, sodium methylate, sodium ethylate, and potassium methylate. Also, an acid catalyst can be used as the saponification catalyst. These can be used alone or in combination of two or more types thereof. The used amount of the saponification catalyst is preferably from 1 to 100 mmol equivalents with respect to the vinyl ester-based compound.

In this manner, such a modified PVA-based resin or an unmodified PVA is obtained.

The average degree of saponification of the PVA-based resin is usually 80 mol % or greater, preferably from 82 to 99.9 mol %, more preferably from 85 to 98 mol %, and preferably from 90 to 96 mol %. When the average degree of saponification is too small, solubility in water tends to decrease or solubility of the film tends to decrease over time depending on an agent to be packaged. When the average degree of saponification is too high, the solubility in water also tends to be reduced. In particular, in the present water-soluble film, when the degree of saponification is too large, the solubility in water tends to decrease.

The average degree of saponification of the modified PVA-based resin is usually 80 mol % or greater, preferably from 85 to 99.9 mol %, and more preferably from 90 to 99 mol %. When the average degree of saponification is too high, solubility in water tends to decrease. When the average degree of saponification is too low, solubility in water tends to decrease over time depending on the agent to be packaged.

When the anionic group-modified PVA-based resin is used as the modified PVA-based resin, the average degree of saponification thereof is preferably from 85 to 99.9 mol %, particularly preferably from 88 to 98 mol %, even more preferably from 90 to 97 mol %, and especially preferably from 90 to 96 mol %. When the average degree of saponification is too high, solubility in water tends to decrease. When the average degree of saponification is too low, solubility in water tends to decrease over time depending on the agent to be packaged.

When the unmodified PVA is used, the average degree of saponification thereof is usually 80 mol % or greater, preferably from 82 to 99 mol %, and more preferably from 85 to 90 mol %. When the average degree of saponification is too small, solubility in water tends to decrease. When the average degree of saponification is too high, the solubility in water also tends to be reduced.

Note that the average degree of saponification of the PVA-based resin means that the average degree of saponification of the entire PVA-based resin contained in the present water-soluble film is within these ranges.

When the present water-soluble film contains a plurality of PVA-based resins, using the proportion and the average degree of saponification of each of the PVA-based resins contained in the entire PVA-based resin, the average degree of saponification of the entire PVA-based resin is determined by Formula described below:

Average degree of saponification of the entire PVA-based resin (A)=content proportion of PVA-based resin (i)×average degree of saponification of PVA-based resin (i)+content proportion of PVA-based resin (ii)×average degree of saponification of PVA-based resin (ii)+ . . . (omitted). (Formula)

The degree of modification of the modified PVA-based resin is usually from 1 to 20 mol %, preferably from 1.5 to 15 mol %, and particularly preferably from 2 to 12 mol %. When the degree of modification is too small, solubility in water tends to decrease. When the degree of modification is too large, productivity of the PVA-based resin tends to decrease, biodegradability tends to decrease, blocking tends to occur, and practicality tends to decrease.

When the anionic group-modified PVA-based resin is used as the modified PVA-based resin, the degree of modification is preferably from 1 to 15 mol %, more preferably from 1.5 to 10 mol %, and particularly preferably from 2 to 8 mol %. When the degree of modification is too small, solubility in water tends to decrease. When the degree of modification is too large, productivity of the PVA-based resin tends to decrease, biodegradability tends to decrease, blocking tends to occur, and practicality tends to decrease.

The viscosity of a 4 mass % aqueous solution of the PVA-based resin at 20 °C is usually from 5 to 60 mPa·s, preferably from 10 to 45 mPa·s, even more preferably from 15 to 40 mPa·s, and particularly preferably from 21 to 35 mPa·s. When the viscosity is too small, mechanical strength tends to decrease. When the viscosity is too large, viscosity of an aqueous solution during film formation becomes high and productivity tends to decrease.

The viscosity of a 4 mass % aqueous solution of the PVA-based resin at 20 °C means that the viscosity of a 4 mass % aqueous solution of the entire PVA-based resin contained in the water-soluble film at 20 °C is within the above range.

The viscosity of a 4 mass % aqueous solution of the modified PVA-based resin at 20 °C is usually from 5 to 50 mPa·s, preferably from 10 to 40 mPa·s, and more preferably from 15 to 35 mPa·s. When the viscosity is too small, mechanical strength tends to decrease. When the viscosity is too large, the viscosity of an aqueous solution during film formation becomes high and productivity tends to decrease.

When the anionic group-modified PVA-based resin is used as the modified PVA-based resin, the viscosity of a 4 mass % aqueous solution thereof at 20 °C is usually from 5 to 50 mPa·s, preferably from 13 to 40 mPa·s, and more preferably from 17 to 30 mPa·s. When the viscosity is too small, mechanical strength tends to decrease. When the viscosity is too large, the viscosity of an aqueous solution during film formation becomes high and productivity tends to decrease.

When the unmodified PVA is used, the viscosity of a 4 mass % aqueous solution thereof at 20 °C is usually from 10 to 60 mPa·s, preferably from 20 to 50 mPa·s, and more preferably from 30 to 45 mPa·s. When the viscosity is too small, mechanical strength tends to decrease. When the viscosity is too large, the viscosity of an aqueous solution during film formation becomes high and productivity tends to decrease.

The average degree of saponification is measured in accordance with JIS K 6726 3.5, and the viscosity of a 4 mass % aqueous solution is measured in accordance with JIS K 6726 3.11.2.

The content of the PVA-based resin is usually from 10 to 70 mass %, preferably from 15 to 65 mass %, more preferably from 20 to 55 mass %, and particularly preferably from 25 to 50 mass %, with respect to the present water-soluble film from the viewpoint of mechanical strength.

When the PVA-based resin contains the unmodified PVA, the mass content ratio of the modified PVA-based resin to the unmodified PVA (modified PVA-based resin/unmodified PVA) is usually from 99/1 to 55/45, preferably from 95/5 to 60/40, and more preferably from 90/10 to 70/30, from the viewpoints of solubility in water and film properties such as sealability.

### Unmodified Starch

The unmodified starch is not particularly limited. Examples thereof include corn starch, potato starch, wheat starch, rice starch, tapioca starch, sweet potato starch, sago palm starch, soybean starch, arrowroot starch, bracken starch, lotus starch, cassava starch, waxy corn starch, high-amylose corn starch, and commercially available amylose powders. One type of these can be used, or two or more types thereof may be used in combination. In particular, waxy corn starch having a high amylopectin content is preferred.

Note that, in the present specification, the term “unmodified starch” means starch not subjected to any chemical treatment, the unmodified starch excluding starch derivatives with a functional group introduced into a hydroxy group of the starch and chemically modified starch derivatives such as oxidized starch.

Examples of the unmodified starch include, in addition to raw starches, physically processed starches subjected to physical treatment such as pregelatinized starch and heat-moisture treated starch (for example, pregelatinized starch, fractionated amylose, and heat-moisture treated starch), decomposition-treated starches decomposed with an acid (such as acid-treated starch), and enzymatically treated starches decomposed by an enzyme (such as hydrolyzed dextrin, enzymatically decomposed dextrin, and amylose). From the viewpoints of solubility in water and miscibility with the PVA-based resin, a physically processed starch is preferred, and pregelatinized starch is more preferred.

The amylopectin content of the unmodified starch is 85% or greater, preferably 90% or greater, more preferably 95% or greater, and even more preferably 98% or greater, from the viewpoints of mechanical properties, moldability, and sealability. The upper limit is not particularly limited and is usually 100%. The range of the amylopectin content is, for example, from 85 to 100%. When the unmodified starch is a mixture of two or more types of unmodified starches, the amylopectin content of the mixture may be 85% or greater.

Note that the unmodified starch described in the present specification does not include starch as a filler described below (that is, starch that exists as 0.1 μm or larger starch particles in the water-soluble film and that disperses in water at approximately normal temperature (20 °C) without gelatinizing).

The amylopectin content means a mass proportion of amylopectin when the total mass of amylose and amylopectin contained in the unmodified starch is 100%.

The amylopectin content can be measured, for example, by a colorimetric method using an iodine reaction product and a quantitation method using concanavalin A as described in Carbohydrate Research, Vol. 180, 301-313 or Starch/Starke, Vol. 42, 302-305.

When the unmodified starch is a mixture of two or more types of unmodified starches, the weighted average of the amylopectin contents of the respective unmodified starches may be used as the amylopectin content of the unmodified starch (mixture), or the amylopectin content of the mixture of the two or more types of starches may be measured by the method described above and the resulting value may be used as the amylopectin content of the unmodified starch.

When the amylopectin content is calculated by the weighted average, based on the amylopectin proportions of the respective unmodified starches, the amylopectin content can be determined by an equation below:

Amylopectin content of unmodified starches (%)=Σ(nₐi×Mₐi)/100
where, nₐi represents an amylopectin content of each of unmodified starches (%); and
Mₐi represents a proportion of each of unmodified starches in the unmodified starch (mass %).

The content of the unmodified starch is preferably from 5 to 80 mass %, more preferably from 10 to 70 mass %, even more preferably from 20 to 60 mass %, and particularly preferably from 30 to 50 mass %, with respect to the present water-soluble film.

The content of the unmodified starch is preferably from 5 to 80 mass %, more preferably from 10 to 70 mass %, even more preferably from 20 to 60 mass %, and particularly preferably from 30 to 55 mass %, with respect to the total mass of the PVA-based resin and the unmodified starch from the viewpoints of mechanical properties, moldability, and sealability. When the proportion of the unmodified starch is in the range described above, mechanical properties, moldability, and sealability tend to be enhanced.

Also, from the viewpoint of compressive strength, the content of the unmodified starch is preferably from 20 to 80 mass %, more preferably from 25 to 70 mass %, and even more preferably from 30 to 55 mass %, with respect to the total mass of the PVA-based resin and the unmodified starch. When the proportion of the unmodified starch is in the range described above, strength tends to be enhanced.

Furthermore, from the viewpoint of moldability, especially moldability into a complex shape, the content of the unmodified starch is preferably from 5 to 50 mass %, more preferably from 10 to 40 mass %, even more preferably from 15 to 38 mass %, and particularly preferably from 20 to 35 mass %, with respect to the total mass of the PVA-based resin and the unmodified starch. When the proportion of the unmodified starch is in the range described above, degree of elongation tends to be excellent.

The content of the unmodified starch is from 20 to 78 mass %, preferably from 50 to 75 mass %, and more preferably from 65 to 75 mass %, with respect to the total mass of the unmodified starch and the plasticizer described below. When the proportion of the unmodified starch is in the range described above, mechanical properties, moldability, and sealability are enhanced.

Also, from the viewpoint of superior moldability, especially superior moldability into a complex shape, the content of the unmodified starch is preferably from 20 to 60 mass %, more preferably from 21 to 50 mass %, and particularly preferably from 22 to 45 mass %, with respect to the total mass of the unmodified starch and the plasticizer described below.

Furthermore, from the viewpoint of superior compressive strength, the content of the unmodified starch is preferably from 65 to 75 mass %, more preferably from 67 to 75 mass %, and particularly preferably from 70 to 75 mass %, with respect to the total mass of the unmodified starch and the plasticizer described below.

The content of the unmodified starch is usually from 20 to 78 mass %, preferably from 30 to 75 mass %, and more preferably from 35 to 75 mass %, with respect to the total mass of the unmodified starch and glycerin (plasticizer) described below. When the proportion of the unmodified starch is in the range described above, mechanical properties, moldability, and sealability tend to be enhanced.

### Plasticizer

The present water-soluble film contains a plasticizer in addition to the PVA-based resin and the unmodified starch from the viewpoint of imparting proper flexibility to the film.

Usually, when an unmodified starch is added to a water-soluble film, the water-soluble film becomes hard and brittle and thus, the mechanical properties, the moldability, and the sealability decrease. On the other hand, in the present disclosure, it was found that, by setting the proportion of the unmodified starch with respect to the total mass of the unmodified starch and the plasticizer to a specific range, i.e., by setting the proportion of the plasticizer to a specific range, mechanical properties, moldability, and sealability are enhanced.

Examples of the plasticizer include glycerins such as glycerin, diglycerin, and triglycerin; alkylene glycols such as diethylene glycol, triethylene glycol, polyethylene glycol, propylene glycol, polypropylene glycol, and dipropylene glycol; sugar alcohols such as sorbitol, xylitol, trehalose, and maltitol; and trimethylolpropane. One type of these can be used, or two or more types thereof may be used in combination. In particular, glycerins and sugar alcohols are preferred, glycerin, sorbitol, and trehalose are more preferred, and glycerin is particularly preferred.

As the plasticizer, from the viewpoint of excellent moldability, especially moldability into a complex shape, glycerin and at least one additional plasticizer are preferably used, and a combination of glycerin and sorbitol and/or trehalose is more preferably used. Because use of glycerin and the at least one additional plasticizer as the plasticizer can enhance tensile elongation at break, moldability into a complex shape tends to be improved.

When glycerin and the at least one additional plasticizer are used as the plasticizer, the mass ratio of glycerin to the at least one additional plasticizer [(glycerin)/(at least one additional plasticizer)] is preferably from 95/5 to 10/90, more preferably from 90/10 to 20/80, and even more preferably from 85/15 to 40/60. When the mass ratio of glycerin to the at least one additional plasticizer is in the range described above, mechanical properties, moldability, especially moldability into a complex shape, and sealability tend to be enhanced.

When the combination of glycerin and sorbitol and/or trehalose is used as the plasticizer, the mass ratio of glycerin to the sorbitol and/or trehalose [(glycerin)/(sorbitol and/or trehalose)] is usually from 95/5 to 10/90, preferably from 90/10 to 20/80, and more preferably from 85/15 to 40/60. When the mass ratio of glycerin to the sorbitol and/or trehalose is in the range described above, mechanical properties, moldability, especially moldability into a complex shape, and sealability tend to be enhanced.

The content of the plasticizer is usually from 5 to 60 mass %, preferably from 8 to 50 mass %, and more preferably from 10 to 45 mass %, with respect to the present water-soluble film. When the content of the plasticizer is in the range described above, mechanical properties, moldability, and sealability tend to be enhanced.

The content of the plasticizer is preferably from 15 to 80 parts by mass, more preferably 20 to 75 parts by mass, and particularly preferably from 40 to 70 parts by mass, with respect to 100 parts by mass in total of the PVA-based resin and the unmodified starch. When the content of the plasticizer is in the range described above, mechanical properties, moldability, and sealability tend to be enhanced.

When glycerin is used as the plasticizer, the content thereof is usually from 10 to 70 parts by mass, preferably from 13 to 50 parts by mass, and more preferably from 15 to 40 parts by mass, with respect to 100 parts by mass in total of the PVA-based resin and the unmodified starch. When the content of glycerin is in the range described above, mechanical properties, moldability, and sealability tend to be enhanced.

Further, when glycerin is used as the plasticizer, the content thereof is preferably 20 mass % or greater, more preferably from 20 to 50 mass %, and even more preferably from 20 to 40 mass %, with respect to the total mass of the unmodified starch and the plasticizer. When the proportion of glycerin is in the range described above, mechanical properties, moldability, and sealability tend to be enhanced.

### Filler

The present water-soluble film may further contain a filler as necessary.

The filler is contained to enhance blocking resistance. The filler is not particularly limited. An organic filler or an inorganic filler may be used as the filler. However, an organic filler is particularly preferably used. These can be used alone or in combination of two or more types thereof. The average particle size of the filler is from 0.1 to 50 μm, and preferably from 1 to 35 μm.

The average particle size of the filler is a value measured by a laser diffraction particle size distribution analyzer and calculated from a D50 value of the obtained cumulative volume distribution (particle size of cumulative 50% of particles).

The organic filler refers to a particulate substance (primary particles) formed of an organic compound and having any form such as a needle-like form, rod-like form, lamellar-like form, scale-like form, or spherical form; or an agglomerate (secondary particles) of the particulate substance.

That is, in the present disclosure, the filler exists in a form that can exhibit blocking resistance in the film, is mixed with the PVA-based resin in the film, and is distinguished from the unmodified starch that does not exhibit blocking resistance.

The organic filler is mainly selected from polymeric compounds. Examples thereof include a melamine-based resin, a polymethyl (meth)acrylate-based resin, a polystyrene-based resin, and biodegradable resins such as starch, modified starch, and polylactic acid. Among these, the biodegradable resins such as starch and polylactic acid are preferred. From the viewpoint of dispersibility in the PVA-based resin, starch is particularly preferred. When starch is used as the organic filler, the amylose content of the starch is preferably less than 85%.

Examples of the starch used as the organic filler include unmodified starches, such as raw starches (such as corn starch, potato starch, sweet potato starch, wheat starch, cassava starch, sago starch, tapioca starch, sorghum starch, rice starch, legume starch, kudzu starch, bracken starch, lotus starch, and water chestnut starch), physically processed starches (such as pregelatinized starch, fractionated amylose, and heat-moisture treated starch), enzymatically treated starches (such as hydrolyzed dextrin, enzymatically decomposed dextrin, and amylose), and decomposition-treated starches (such as acid-treated starch); and modified starches, such as chemically modified starch derivatives (such as esterified starch, etherified starch, cationized starch, and crosslinked starch) and oxidized starch. Among these, raw starches are preferred, and use of corn starch and rice starch is more preferred from the viewpoints of availability and cost efficiency.

The average particle size of the organic filler is preferably from 2 to 50 μm, more preferably from 4 to 45 μm, particularly preferably from 10 to 40 μm, and even more preferably from 15 to 35 μm. When the average particle size is too small, the film tends to have increased blocking properties. When the average particle size is too large, there is a tendency that the particles of the filler are likely to aggregate with each other and dispersibility is reduced, or pinholes are generated when the film is stretched during film processing.

The inorganic filler refers to a particulate substance (primary particles) formed of an inorganic compound and having any form such as a needle-like form, rod-like form, lamellar-like form, scale-like form, or spherical form; or an agglomerate (secondary particles) of the particulate substance.

Examples of the inorganic filler include oxide-based inorganic compounds such as silica (silicon dioxide), diatomite, titanium oxide, calcium oxide, magnesium oxide, aluminum oxide, barium oxide, germanium oxide, tin oxide, and zinc oxide; talc, clay, kaolin, mica, asbestos, gypsum, graphite, glass balloons, glass beads, calcium sulfate, barium sulfate, ammonium sulfate, calcium sulfite, calcium carbonate, whiskered calcium carbonate, magnesium carbonate, dawsonite, dolomite, potassium titanate, carbon black, glass fibers, alumina fibers, boron fibers, processed mineral fibers, carbon fibers, hollow carbon spheres, bentonite, montmorillonite, copper powder, sodium sulfate, potassium sulfate, zinc sulfate, copper sulfate, iron sulfate, magnesium sulfate, aluminum sulfate, aluminum potassium sulfate, ammonium nitrate, sodium nitrate, potassium nitrate, aluminum nitrate, ammonium chloride, sodium chloride, potassium chloride, magnesium chloride, calcium chloride, sodium phosphate, and potassium chromate. One type of these can be used, or two or more types thereof may be used in combination.

Among these, use of an oxide-based inorganic compound or talc is preferred, use of titanium oxide, talc, or silica is more preferred, and use of silica is even more preferred.

The average particle size of the inorganic filler is preferably from 1 to 20 μm, more preferably from 2 to 15 μm, and even more preferably from 3 to 10 μm. When the average particle size is too small, the film tends to have lowered flexibility and toughness and tends to have increased blocking properties, for example. When the average particle size is too large, pinholes tend to be generated when the film is stretched during film processing.

The content of the filler is preferably from 1 to 15 parts by mass, more preferably from 1.5 to 12 parts by mass, and even more preferably from 2 to 10 parts by mass, with respect to 100 parts by mass in total of the unmodified starch and the PVA-based resin. When the content proportion is too low, the film tends to have increased blocking properties. When the content proportion is too high, the flexibility and the toughness of the film tend to be reduced.

### Surfactant

The present water-soluble film can further contain, for example, a surfactant as necessary.

The surfactant is contained for the purpose of improving the peelability from a cast surface during production of the film. Typical examples of the surfactant include a nonionic surfactant, a cationic surfactant, and an anionic surfactant.

Examples of the surfactant include polyoxyethylene nonylphenyl ether, polyoxyethylene octylnonyl ether, polyoxyethylene dodecylphenyl ether, polyoxyethylene alkylallyl ether, polyoxyethylene sorbitan monolaurate, polyoxyethylene sorbitan monopalmitate, polyoxyethylene sorbitan monostearate, polyoxyethylene sorbitan monooleate, polyoxyalkylene alkyl ether phosphate ester monoethanolamine salts, polyoxyethylene alkylamino ethers such as polyoxyethylene laurylamino ether and polyoxyethylene stearylamino ether, sorbitan monopalmitate, sorbitan monostearate, glyceryl stearate, and sucrose fatty acid esters. One type of these surfactants may be used, or two or more types thereof may be used in combination. In particular, a polyoxyalkylene alkyl ether phosphate ester monoethanolamine salt and polyoxyethylene laurylamino ether are preferred from the viewpoint of production stability.

The content of the surfactant is preferably from 0.01 to 3 parts by mass, particularly preferably from 0.05 to 2.5 parts by mass, and even more preferably from 0.1 to 2 parts by mass, with respect to 100 parts by mass in total of the PVA-based resin and the unmodified starch. When the content is too low, the peelability between a cast surface of a film forming apparatus and the formed film tends to be reduced, and thus productivity tends to decrease. When the content is too high, blocking tends to occur more easily and adhesive strength during sealing when a package is formed using the film tends to decrease.

### Additional Component

The present water-soluble film can contain an additional component as long as the purpose of the invention is not impaired, examples of the additional component including an additional water-soluble polymer other than the PVA-based resin (for example, sodium polyacrylate, polyethylene oxide, polyvinylpyrrolidone, dextrin, chitosan, chitin, methylcellulose, and hydroxyethyl cellulose), a perfume, an antirust agent, a colorant, a bulking agent, an antifoaming agent, an ultraviolet absorber, liquid paraffins, a fluorescent brightener, and a bitterness component (e.g., denatonium benzoate). One type of these can be used, or two or more types thereof may be used in combination.

The content of the additional component is preferably 5 parts by mass or less, particularly preferably 1 part by mass or less, and more preferably 0.5 parts by mass or less, with respect to 100 parts by mass in total of the PVA-based resin and the unmodified starch. The lower limit value is usually 0 parts by mass.

The present water-soluble film may contain an antioxidant. Examples of the antioxidant include sulfites such as sodium sulfite, potassium sulfite, calcium sulfite, and ammonium sulfite; tartaric acid, ascorbic acid, sodium thiosulfate, catechol, and Rongalit. Among these, a sulfite, especially sodium sulfite, is preferred. The blended amount thereof is preferably from 0.1 to 10 parts by mass, particularly preferably from 0.2 to 5 parts by mass, and even more preferably from 0.3 to 3 parts by mass, with respect to 100 parts by mass in total of the PVA-based resin and the unmodified starch.

### Production of Water-Soluble Film

For the present water-soluble film, the PVA-based resin, the unmodified starch, and the plasticizer and, as necessary, additional components such as the filler and the surfactant described above are blended, dissolved or dispersed using water to prepare a film-forming raw material, and the film-forming raw material is formed into a film. The production of the water-soluble film includes a casting step of casting the film-forming raw material onto a cast surface and a drying step of drying the cast film-forming raw material.

### Dissolution Step

In a dissolution step, the components blended as described above are dissolved or dispersed in water to prepare an aqueous solution or an aqueous dispersion serving as a film-forming raw material.

When the film-forming raw material is prepared, the mixing method of the PVA-based resin, the unmodified starch, the plasticizer, and an additional additive is not particularly limited. Examples thereof include (i) a method including mixing the PVA-based resin, the unmodified starch, and the plasticizer, and the additional component to form a mixture and mixing the mixture with water to dissolve the mixture in water, (ii) a method including dissolving the PVA-based resin, the plasticizer, and the additional component in water and then mixing the unmodified starch with the resulting aqueous mixture, (iii) a method including dissolving the PVA-based resin in water, dissolving the unmodified starch in water, dissolving the plasticizer in water, and dissolving the additional component in water, separately and respectively, and then mixing the resulting aqueous mixtures, and (iv) a method including dissolving the PVA-based resin in water and dissolving the unmodified starch in water, separately and respectively, and then mixing the resulting aqueous mixtures with the plasticizer and the additional component to be dissolved.

For example, normal-temperature dissolution, high-temperature dissolution, or dissolution under pressure is usually employed as a dissolution method for dissolution in water. Among these, high-temperature dissolution and dissolution under pressure are preferred from the viewpoints of less undissolved matter and excellent productivity.

The dissolution temperature is usually from 80 to 100 °C and preferably from 90 to 100 °C in the case of the high-temperature dissolution. In the case of the dissolution under pressure, the dissolution temperature is usually from 80 to 130 °C and preferably from 90 to 120 °C. In particular, the dissolution temperature of the unmodified starch is preferably from 50 to 90 °C, more preferably from 55 to 85 °C, and even more preferably from 60 to 80 °C.

The dissolution time is usually from 1 to 20 hours, preferably from 2 to 15 hours, and more preferably from 3 to 10 hours. When the dissolution time is too short, an undissolved material tends to remain. When the dissolution time is too long, productivity tends to decrease.

After the dissolution, a defoaming treatment is further performed for the obtained film-forming raw material. Examples of the defoaming method include stationary defoaming, vacuum defoaming, and twin-screw extrusion defoaming. Among these, stationary defoaming and twin-screw extrusion defoaming are preferred.

The defoaming temperature is usually from 50 to 100 °C, preferably from 55 to 95 °C, and particularly preferably from 60 to 80 °C. When the defoaming temperature is too low, there is a tendency that viscosity becomes high, it takes a longer time for defoaming, and thus productivity decreases.

The defoaming time is usually from 2 to 30 hours, and preferably from 5 to 25 hours.

The solid content concentration of the film-forming raw material is preferably from 10 to 60 mass %, more preferably from 12 to 50 mass %, and even more preferably from 15 to 40 mass %. When the concentration is too low, the productivity of the film tends to be reduced. When the concentration is too high, there is a tendency that viscosity is too high, it takes a longer time to defoam the film-forming raw material, and a die line is generated during film formation.

The pH of the film-forming raw material is usually from 4 to 8, and preferably from 4.8 to 7.5.

### Film Forming Step

In a film forming step, the film-forming raw material prepared in the dissolution step is shaped into a film shape and optionally subjected to drying treatment to prepare a water-soluble film having a specific moisture content.

As the film formation method, a melt extrusion method or a casting method can be employed, for example. From the viewpoint of accuracy in film thickness, the casting method is preferred.

When the casting method is performed, for example, the film-forming raw material is ejected from a slit such as a T-shaped slit die and cast onto a cast surface such as a metal surface of an endless belt or a drum roll or a plastic substrate surface such as a polyethylene terephthalate film. Subsequently, the cast material is dried and is optionally subjected to further heat-treatment. Thus, the water-soluble film can be produced.

The water-soluble film peeled from the cast surface such as the plastic substrate surface in the film forming step is conveyed and wound around a core tube, and thus a film roll is obtained. The obtained film roll can be supplied as a product as it is, but preferably, the film roll can also be supplied as a film roll with the water-soluble film slit into a film width having a desired size.

The surface of the obtained present water-soluble film may be plain. However, from the viewpoints of blocking resistance, slipping during processing, reduction in adhesion between products, and appearance, one face or both of the faces of the film is preferably subjected to uneven processing such as an embossed pattern, a fine uneven pattern, and a special engraved pattern.

The thickness of the present water-soluble film is appropriately selected depending on, for example, the application, but is preferably from 10 to 120 μm, more preferably from 15 to 110 μm, and even more preferably from 20 to 100 μm. When the thickness is too small, the mechanical strength of the film tends to be reduced. When the thickness is too large, the rate of dissolution in water tends to be reduced and the film forming efficiency also tends to be reduced.

The width of the present water-soluble film is appropriately selected depending on, for example, the application, but is preferably from 300 to 5000 mm, more preferably from 500 to 4000 mm, and even more preferably from 600 to 3000 mm. When the width is too small, productivity tends to decrease. When the width is too large, controlling of slack and film thickness tends to become difficult.

The length of the present water-soluble film is appropriately selected depending on, for example, the application, but is preferably from 100 to 20000 m, more preferably from 800 to 15000 m, and even more preferably from 1000 to 10000 m. When the length is too small, film switching requires time and effort, and thus productivity tends to decrease. When the length is too large, tight winding tends to result in poor appearance.

The moisture content of the present water-soluble film is preferably from 3 to 15 mass %, more preferably from 5 to 9 mass %, and even more preferably from 6 to 8 mass %, from the viewpoints of mechanical strength and heat sealability. When the content is too low, the film tends to be too hard, moldability when a package is formed or impact resistance of the package tends to be reduced. When the moisture content is too high, blocking tends to occur more easily. The moisture content can be adjusted by appropriately setting the drying conditions and the humidity control conditions.

The moisture content is measured in accordance with JIS K 6726 3.4, and the resulting volatile content is defined as the moisture content.

The present water-soluble film may be used as a single layer or as a multilayer structure with another film or resin layer being laminated.

The present water-soluble film is particularly useful for packaging (unit packaging) applications for chemical agents, such as agrochemicals and detergents, and edible applications (food packaging). The food product to be packaged by the film may be, for example, in a granular form, a tablet form, or a powdery form. Alternatively, the food may be a dried food, for example, an ingredient and a seasoning for instant foods. In particular, because the present water-soluble film has excellent mechanical properties, moldability, and sealability, the present water-soluble film is suitable for a composite packaging (for example, for a 2 in pouch or a 3 in pouch) containing, in a single package, two or more types, preferably three types of chemical agents separately and respectively packaged.

### Chemical Agent Package

A chemical agent package according to an embodiment of the present disclosure (hereinafter may be referred to as “the present package”) is produced by covering a chemical agent with a package formed of the obtained water-soluble film. In the present package, the chemical agent is packaged in the package formed of the present water-soluble film. Thus, when the chemical agent is put into water together with the package, the surface of the package (the present water-soluble film) dissolves, the chemical agent is exposed, and the chemical agent is dissolved or dispersed in water. Thus, the chemical agent can exhibit its effect. Therefore, the present package is suitable as a chemical agent package containing a relatively small amount, for example, a single unit of the chemical agent.

The shape of the present package is appropriately selected and is not particularly limited. Examples of the shape of the present package include a substantially cubic shape, a substantially spherical shape, a substantially oblate spheroidal shape, and a substantially teardrop shape. The present package may be composed of a single compartment or have a plurality of compartments.

The number of compartments of the plurality of compartments in the present package is appropriately selected, for example, based on the type of the content and is not particularly limited. Examples thereof include from 2 to 10 compartments, from 3 to 8 compartments, and more preferably from 4 to 6 compartments. Also, it is preferable that different types of contents are packaged in the respective compartments of the plurality of compartments.

The surface of the present package is usually smooth, for example. However, from the viewpoints of blocking resistance, slipping during processing, reduction in adhesion between products (individual packages), and appearance, an outer surface of the package (water-soluble film) may be subjected to uneven processing such as an embossed pattern, a fine uneven pattern, and a special engraved pattern.

Examples of the chemical agent include agricultural chemicals such as insecticides, fungicides, and herbicides; fertilizers; and detergents. In particular, detergents such as laundry detergents and dishwashing detergents are preferred. Such a chemical agent may be in the form of liquid or solid, and examples of the solid form include a granular form, a tablet form, and a powdery form. The chemical agent is preferably a chemical agent used by dissolving or dispersing such a chemical agent in water, and it is particularly preferable to enclose a liquid detergent. The pH of such a chemical agent may be alkaline, neutral, or acidic.

The liquid detergent has a pH value of preferably 6 to 12, particularly preferably 6 to 10, more preferably 6 to 9, and especially preferably 7 to 8, when the liquid detergent is dissolved or dispersed in a concentration of 1% in water. The water content of the liquid detergent is preferably 15 mass % or less, particularly preferably from 0.1 to 10 mass %, and more preferably from 0.1 to 7 mass %. When the water content of the liquid detergent is in the range described above, the water-soluble film tends to be free from gelation or insolubilization and tends to have excellent water solubility.

The pH value is measured in accordance with JIS K 3362 8.3. The water content is measured in accordance with JIS K 3362 7.21.3.

### Production of Present Package

To form the present package by packaging a chemical agent such as a liquid detergent using the present water-soluble film, a known method can be employed.

For example, the present package can be produced by preparing a first water-soluble film, a second water-soluble film, and a chemical agent, placing the chemical agent between the first water-soluble film and the second water-soluble film, and bringing the first water-soluble film and the second water-soluble film into contact with each other; and pressure-bonding the contact portion of the first water-soluble film and the second water-soluble film.

Specifically, a film (bottom film) is fixed to a lower mold of a molding apparatus and the bottom film is molded into a shape along the lower mold (a shape that allows a chemical agent to be arranged inside the bottom film).

Meanwhile, a film (top film) is fixed to an upper mold of the molding apparatus. Subsequently, a separately prepared chemical agent such as a liquid detergent is placed (charged) into the molded bottom film, and then the molds are compressed to bring the top film and the bottom film into contact with each other, and the contact portion is pressure-bonded under vacuum. After the pressure-bonding, the vacuum is released. Thus, a chemical agent package (present package) with the chemical agent enclosed in the water-soluble film can be produced.

Examples of the method of pressure-bonding the film include a heat-sealing method, a water-sealing method, and a glue-sealing method. Among these, a water-sealing method is preferably used from the viewpoint of easy control, for example, of pressure-bonding conditions.

### EXAMPLES

Hereinafter, the present disclosure will be described more specifically with reference to Examples. However, the present disclosure is not limited to Examples below to the extent such that the gist of the present disclosure is not exceeded.

In Examples, “part(s)” is meant to be on a mass basis.

As raw material components of a water-soluble film, the following materials were prepared.

### PVA-Based Resin

Modified PVA-based resin: A carboxy group-modified PVA-based resin having a viscosity of a 4% aqueous solution of 22 mPa·s at 20 °C, an average degree of saponification of 94 mol %, and a degree of modification with monomethyl maleate of 2.2 mol %
Unmodified PVA: viscosity of a 4% aqueous solution of 43 mPa·s at 20 °C, and an average degree of saponification of 88 mol %

### Unmodified Starch

(i) Pregelatinized Starch (amylopectin content: 100%; “Waxy Alpha Y”, available from Sanwa Starch Co., Ltd.)
(ii) Pregelatinized Starch (amylopectin content: 75%; “Corn Alpha W”, available from Sanwa Starch Co., Ltd.)

### Natural Raw Material

Casein (“Casein Sodium 180”, available from Fonterra Co-operative

### Group Limited

Plasticizer
Glycerin
Sorbitol
Trehalose

### Example 1

Together with water, 42 parts of the modified PVA-based resin as a PVA-based resin, 42 parts of (i) pregelatinized starch as an unmodified starch, 16 parts of glycerin as a plasticizer were mixed and the mixture was subjected to dissolution treatment to yield a film-forming raw material as an aqueous dispersion of a resin composition having a solid content concentration of 30%. The obtained film-forming raw material was defoamed by allowing the film-forming raw material to stand still at 80 °C for 24 hours.

The film-forming raw material after the defoaming by standing was cast on a polyethylene terephthalate film and passed through a drying chamber (105 °C) having a length of 3 m at a speed of 0.5 m/min and dried, and thus a water-soluble film having a thickness of 87 μm was produced.

### Examples 2 to 5, Comparative Example 1, and Comparative Example 3

Water-soluble films were produced in the same manner as in Example 1, except that the compositions of resin compositions were changed as listed in Table 1 below.

### Comparative Example 2

A water-soluble film was produced in the same manner as in Example 1, except that the composition of a resin composition was changed as listed in Table 1 below and the defoaming temperature was set to 60 °C.

### Reference Example 1

A water-soluble film was produced in the same manner as in Example 1, except that the composition of a resin composition was changed as listed in Table 1 below and the solid content concentration of a film-forming raw material was set to 25%.

Using each of the water-soluble films obtained as described above, mechanical properties and water solubility thereof were evaluated by methods and criteria described below. The results are listed in Table 1 below.

### Mechanical Properties

Using each of the obtained water-soluble films, “tensile strength” and “tensile elongation at break” were measured in accordance with JIS K 7127 (1999). That is, before the measurement, each of the water-soluble films was allowed to stand still under humidity control conditions of 23 °C and 50% RH for 24 hours. Next, under this environment, the tensile strength and the tensile elongation at break of each of the water-soluble films were measured by using Autograph AG-X Plus (available from Shimadzu Corporation) at a tensile speed of 200 mm/min (film width: 15 mm; distance between grips: 50 mm). These measurement values were evaluated based on the following criteria:

### Evaluation Criterion for Tensile Strength

A . . . 12 MPa or greater
B . . . 5 MPa or greater and less than 12 MPa
C . . . less than 5 MPa

### Evaluation Criterion for Tensile Elongation at Break

A . . . 300% or greater
B . . . 200% or greater and less than 300%
C . . . less than 200%

### Overall Evaluation

◯ (very good) . . . . B or higher and at least one is A
Δ (good) . . . both are B
x (poor) . . . at least one is C.

### Solubility

Each of the water-soluble films obtained as described above was cut into a size of 3.5 cm×3.5 cm, placed in a 1-liter beaker containing water (1 liter), and fixed with a jig, and the mixture was stirred with a stirrer (a rotator length of 3 cm, a rotation speed of 750 rpm) while the water temperature was maintained at 20 °C. When dispersion of insoluble fine particles of the film having a diameter of 1 mm or greater was not observed, such a case was regarded as dissolution. The time required for the dissolution was evaluated based on the following criteria:

### Evaluation Criteria

∘ (very good) . . . . Dissolution was completed in shorter than 90 seconds.
Δ (good) . . . . Dissolution was completed in 90 to 180 seconds.
x (poor) . . . . Dissolution was not completed even after 180 seconds.

Using each of the water-soluble films obtained as described above, a package was produced by a method described below, and the moldability and the compressive strength were evaluated by methods and criteria described below. These results are listed in Table 1 below.

### Preparation of Package (1 in Pouch)

A package was prepared by the following procedure using each of the water-soluble films obtained as described above and a package production apparatus available from ENGEL.

That is, each of the water-soluble films was allowed to stand still under humidity control conditions of 23 °C and 40% RH for 24 hours, and thus humidity control was performed. Next, under this environment, a first water-soluble film (bottom film) was fixed on a mold having a recessed part at a bottom part of the apparatus (package to be molded: 45 mm in length, 42 mm in width, and 30 mm in height). A second water-soluble film (top film) was also fixed at an upper part of the apparatus such that the second water-soluble film was faced to the bottom film. The bottom film was heated for 4 seconds by a dryer configured to generate hot air at 100 °C and subjected to vacuum molding to mold the bottom film into a shape along the mold.

Next, 34 mL of a commercially available liquid laundry detergent for clothing (summary of the composition: 11% propylene glycol, 7.5% glycerin, 67% surfactant, and 14.2% water; pH 7.5) was charged in a recessed part of the molded bottom film. Onto the entire surface of the top film (80 mm in length and 140 mm in width), 0.25 g of water was applied. The top film and the bottom film were pressure-bonded for 10 seconds, vacuum was released after the pressure-bonding, and thus a package (1 in pouch) was produced.

### Moldability (1 in Pouch)

In the production of the package (1 in pouch), conformability of the bottom film to the mold during vacuum molding was visually observed and evaluated based on the following criteria:

### Evaluation Criteria

∘ (very good) . . . . The water-soluble film sufficiently conformed to the mold in shorter than 30 seconds.
Δ (good) . . . . A slight gap was observed between the water-soluble film and the mold, or it took 30 seconds or longer for the water-soluble film to sufficiently conform to the mold.
x (poor) . . . . The water-soluble film was obviously separated from the mold and did not conform to the mold, and a package could not be produced.

### Compressive Strength

The package (1 in pouch) produced by the method described above was allowed to stand still in an environment at 23 °C and 40% RH for 1 hour. Next, under this environment, the compressive strength at rupture of the liquid detergent package was measured by using Autograph AG-X Plus (available from Shimadzu Corporation) at a test speed of 200 mm/min. Evaluation was performed based on the following evaluation criteria. Note that a 5 kN load cell was used.

### Evaluation Criteria

∘ (very good) . . . . The compressive strength was 250 N or greater.
Δ (good) . . . . The compressive strength was 200 N or greater and less than 250 N.
x (poor) . . . . The pouch was ruptured easily at a compressive strength of less than 200 N, or the pouch was ruptured due to the sealing face being easily peeled off.

### Preparation of Package (3 in Pouch)

A package was prepared by the following procedure using each of the water-soluble films obtained as described above and a package production apparatus available from ENGEL.

That is, each of the water-soluble films was allowed to stand still under humidity control conditions of 23 °C and 40% RH for 24 hours for humidity control. Next, under this environment, a first water-soluble film (bottom film) was fixed on a mold having a recessed part having three separate compartments at a bottom part of the apparatus (package to be molded: 45 mm in length, 45 mm in width, and 20 mm in height). A second water-soluble film (top film) was also fixed at an upper part of the apparatus such that the second water-soluble film was faced to the bottom film. The bottom film was heated for 4 seconds by a dryer configured to generate hot air at 100 °C and subjected to vacuum molding to mold the bottom film into a shape along the mold.

Next, 34 mL of a commercially available liquid laundry detergent for clothing (summary of the composition: 11% propylene glycol, 7.5% glycerin, 67% surfactant, and 14.2% water; pH 7.5) was charged in a recessed part of the molded bottom film. Onto the entire surface of the top film (80 mm in length and 140 mm in width), 0.25 g of water was applied. The top film and the bottom film were pressure-bonded for 10 seconds, then vacuum was released, and thus a package (3 in pouch) was produced.

### Moldability (3 in Pouch)

In the production of the package (3 in pouch), conformability of the bottom film to the mold during vacuum molding and appearance of the obtained package were visually observed and evaluated based on the following criteria:

### Evaluation Criteria

⊚ (excellent) . . . . The water-soluble film uniformly conformed to all the three compartments of the mold in shorter than 30 seconds, and a perfect package having no wrinkles, deformation, and collapse in all the compartments was produced.
∘ (very good) . . . . The water-soluble film conformed to all the three compartments of the mold in shorter than 30 seconds, and a practically usable package was produced although the produced package had slight wrinkles, deformation, and insufficient tension that were not problematic for use.
Δ (good) . . . . It took 30 seconds or longer for the water-soluble film to conform to all the three compartments of the mold. Alternatively, although the water-soluble film conformed to all the three compartments of the mold in shorter than 30 seconds, the produced package had wrinkles, deformation, and insufficient tension that were somewhat problematic for use.
x (poor) . . . . The water-soluble film did not sufficiently conform to the mold and was obviously separated from the mold, and thus a package could not be produced. Alternatively, the produced package had obvious breakage, wrinkles, deformation, and collapse and was not suitable for practical use.

TABLE 1
(part)

| | | | | | | | Compar- | Compar- | Compar- | Refer- |
|---|---|---|---|---|---|---|---|---|---|---|
| | | Exam- | Exam- | Exam- | Exam- | Exam- | ative | ative | ative | ence |
| | | ple 1 | ple 2 | ple 3 | ple 4 | ple 5 | Example 1 | Example 2 | Example 3 | Example 1 |
| PVA-based | Modified PVA-based resin | 42 | 45 | 45 | 40 | 37 | 45 | 42 | 45 | 84 |
| resin | Unmodified PVA | — | — | — | — | 5 | — | — | — | — |
| Unmodified | (i) Amylopectin content | 42 | 15 | 15 | 35 | 42 | 45 | — | — | — |
| starch | 100% | | | | | | | | | |
| | (ii) Amylopectin content | — | — | — | — | — | — | — | 15 | — |
| | 75% | | | | | | | | | |
| Casein | | — | — | — | — | — | — | 42 | — | — |
| Plasticizer | Glycerin | 16 | 20 | 20 | 20 | 16 | — | 16 | 20 | 16 |
| | Sorbitol | — | — | 20 | 5 | — | 10 | — | — | — |
| | Trehalose | — | 20 | — | — | — | — | — | 20 | — |
| Unmodified starch content 1*¹ (mass %) | | 72 | 27 | 27 | 58 | 72 | 82 | — | 27 | — |
| Unmodified starch content 2*² (mass %) | | 50 | 25 | 25 | 47 | 50 | 50 | — | 25 | — |
| Mechanical | Tensile strength | A | B | B | B | A | A | B | B | A |
| properties | Tensile elongation | B | A | A | A | B | C | C | A | A |
| | at Break | | | | | | | | | |
| | Overall | ◯ | ◯ | ◯ | ◯ | ◯ | X | X | ◯ | ◯ |
| | evaluation | | | | | | | | | |
| Solubility | Evaluation | ◯ | ◯ | ◯ | ◯ | ◯ | ◯ | Δ | X | ◯ |
| Moldability (1 in pouch) | Evaluation | ◯ | ◯ | ◯ | ◯ | ◯ | X | ◯ | — | ◯ |
| Compressive strength | Evaluation | ◯ | ◯ | ◯ | ◯ | ◯ | — | X | — | ◯ |
| Moldability (3 in pouch) | Evaluation | ◯ | ⊙ | ⊙ | ⊙ | ◯ | — | X | — | ⊙ |

*¹Content of unmodified starch with respect to total mass of unmodified starch and plasticizer
*²Content of unmodified starch with respect to total mass of PVA-based resin and unmodified starch

From the results of Table 1, the water-soluble films of Examples had mechanical properties and solubility equivalent to those of the water-soluble film of Reference Example 1 in the related art which did not contain the unmodified starch.

In addition, each of the water-soluble films of Examples had excellent moldability even in a complex shape and further exhibited sufficient strength in the evaluation of the compressive strength. In addition, all of the water-soluble films of Examples were not easily peeled off and ruptured in the respective sealing parts. Thus, it was found that the water-soluble films of Examples had excellent strength in the respective seal parts.

On the other hand, the water-soluble film of Comparative Example 1, which had a content of the unmodified starch out of the range specified in the present disclosure with respect to the total mass of the unmodified starch and the plasticizer, had lower tensile elongation at break and inferior mechanical properties compared to those of the water-soluble films of Examples. In addition, the water-soluble film of Comparative Example 1 could not form a package because the moldability was poor during the package production.

Also, the water-soluble film of Comparative Example 2, which used casein as a natural raw material in place of the unmodified starch, had lower tensile elongation at break, inferior mechanical properties, and inferior compressive strength when a package was formed, compared to those of the water-soluble films of Examples.

The water-soluble film of Comparative Example 3, which had an amylopectin content of the unmodified starch out of the range specified in the present disclosure, had inferior water solubility compared to those of the water-soluble films of Examples.

Specific embodiments of the present disclosure were described in Examples, but Examples are merely illustrative and are not to be construed as limiting. Various modifications apparent to those skilled in the art are intended to be within the scope of the present disclosure.

### INDUSTRIAL APPLICABILITY

The water-soluble film of the present disclosure can be used for packaging (unit packaging) applications of chemical agents such as agrochemicals and detergents; (hydraulic) transfer films; sanitary products such as sanitary pads and disposable diapers; bodily waste disposal products such as ostomy bags; medical products such as blood absorbent sheets; and temporary base materials such as germination sheets, seed tapes, and embroidery base fabrics.

In addition, the film of the present disclosure is a blend film of a natural raw material and a PVA-based resin, both of which are used in food products and medical and pharmaceutical products. Thus, the film of the present disclosure is also useful for edible applications (food packaging).

1. A water-soluble film comprising a polyvinyl alcohol-based resin, an unmodified starch, and a plasticizer, wherein
the polyvinyl alcohol-based resin contains a modified polyvinyl alcohol-based resin,
the unmodified starch has an amylopectin content of 85% or greater, and
a content of the unmodified starch is from 20 to 78 mass % with respect to a total mass of the unmodified starch and the plasticizer.

2. The water-soluble film according to claim 1, wherein the content of the unmodified starch is from 20 to 60 mass % with respect to the total mass of the unmodified starch and the plasticizer.

3. The water-soluble film according to claim 1, wherein the content of the unmodified starch is from 65 to 75 mass % with respect to the total mass of the unmodified starch and the plasticizer.

4. The water-soluble film according to claim 1, wherein the content of the unmodified starch is from 20 to 80 mass % with respect to a total mass of the polyvinyl alcohol-based resin and the unmodified starch.

5. The water-soluble film according to claim 1, wherein the plasticizer contains glycerin.

6. The water-soluble film according to claim 1, wherein the plasticizer comprises glycerin and at least one additional plasticizer, and a mass ratio of glycerin to the at least one additional plasticizer [(glycerin)/(at least one additional plasticizer)] is from 95/5 to 10/90.

7. The water-soluble film according to claim 1, wherein an average degree of saponification of the polyvinyl alcohol-based resin is from 80 to 96 mol %.

8. The water-soluble film according to claim 1, wherein the water-soluble film is configured for chemical agent packaging.

9. A chemical agent package comprising a package formed of the water-soluble film according to claim 1, and a chemical agent contained in the package.
